(19) United States
(12) Patent Application Publication
(10) Pub. No.: US 2022/0309387 A1
(43) Pub. Date: Sep. 29, 2022

(54) COMPUTER-BASED SYSTEMS FOR METADATA-BASED ANOMALY DETECTION AND METHODS OF USE THEREOF

(71) Applicant: Capital One Services, LLC, McLean, VA (US)

(72) Inventors: Judith Rodriguez, Falls Church, VA (US); Clayton Johnson, Edgewood, MD (US); Cara Weikel, Silver Spring, MD (US); Rocky Gray, Fairfax, VA (US)

(21) Appl. No.: 17/214,231

(22) Filed: Mar. 26, 2021

(51) Int. Cl. G06N 20/00; G06F 16/383; G06F 16/35; G06K 9/62; H04L 9/32

(52) U.S. Cl. CPC G06N 20/00; G06F 16/383; G06F 16/358; G06K 9/623; H04L 9/3213

(57) ABSTRACT

Systems and methods for providing metadata-based anomaly detection, comprising: storing a plurality of sets of electronic documents associated with a plurality of users; generating a set of metadata items for each document in each set of the plurality of sets of documents; determining a set of features based on the set of metadata items for each document in each set of the plurality of sets of documents; transforming the set of features into a set of feature vectors, each feature vector tagged to indicate a correspondence to a particular anomaly or not; and training, based at least in part on the set of features vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items.

### FIELD OF TECHNOLOGY

The present disclosure generally relates to improved metadata extraction/processing, improved anomaly detection/handling, improved computer-based platforms or systems, improved computing components and devices, improved computer-readable media, and/or improved computing methods configured for one or more novel technological applications involving metadata-based anomaly detection and/or processing.

### BACKGROUND OF TECHNOLOGY

A typical computer platform/system may produce anomalies during its operations that might be in the form of rare events which raise suspicions by differing significantly from the majority of events occurring within the computer platform/system.

### SUMMARY OF DESCRIBED SUBJECT MATTER

In some embodiments, the present disclosure provides various exemplary technically improved method for metadata-based anomaly detection, comprising operations such as storing, by one or more processors of a platform, a plurality of sets of electronic documents associated with a plurality of users, each set of the plurality of sets of electronic documents corresponding to an account of each user of the plurality of users; generating, by the one or more processors, a set of metadata items for each electronic document in each set of the plurality of sets of electronic documents, the set of metadata items comprising one or more data fields indicative of states of activities associated with each set of electronic documents; determining, by the one or more processors, a set of features based on the set of metadata items for each electronic document in each set of the plurality of sets of electronic documents; transforming, by the one or more processors, the set of features into a set of feature vectors, each feature vector tagged to indicate a correspondence to a particular anomaly or not; training, by the one or more processors, based at least in part on the set of features vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items; utilizing, by the one or more processors, the trained data anomaly-detection machine learning model to analyze a particular set of metadata items of at least one particular electronic document associated with an account of a particular user of the plurality of users to detect one or more anomalies in the particular set of metadata items; and automatically triggering, by the one or more processors and in response to the one or more anomalies, one or more actions associated with the account of the particular user.

In some embodiments, the present disclosure also provides exemplary technically improved computer-based systems, computer-implemented methods, and computer-readable media, including media implemented with and/or involving one or more software applications, whether resident on computer devices or platforms, provided for download via a server and/or executed in connection with at least one network such as via a web browser application, that include or involves features, functionality, computing components and/or steps consistent with those set forth herein.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of an exemplary system and/or platform involving features of metadata-based anomaly detection, consistent with exemplary aspects of certain embodiments of the present disclosure.

FIGS. 2A-2B are block diagrams of exemplary metadata-based anomaly detection systems, consistent with exemplary aspects of certain embodiments of the present disclosure.

FIGS. 3A-3B are flow diagrams depicting certain illustrative aspects of exemplary interactions of metadata-based anomaly detection systems, consistent with exemplary aspects of certain embodiments of the present disclosure.

FIG. 4 is a flowchart depicting an exemplary method associated with an illustrative metadata-based anomaly detection system, consistent with exemplary aspects of certain embodiments of the present disclosure.

FIG. 5 is a block diagram depicting an exemplary computer-based system and/or platform, in accordance with certain embodiments of the present disclosure.

FIG. 6 is a block diagram depicting another exemplary computer-based system and/or platform, in accordance with certain embodiments of the present disclosure.

FIGS. 7 and 8 are diagrams illustrating two exemplary implementations of cloud computing architecture/aspects with respect to which the disclosed technology may be specifically configured to operate, in accordance with certain embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

As explained in more detail, below, enhanced systems, and methods for providing metadata-based anomaly detection are disclosed. According to some aspects, such as in connection with exemplary enhanced metadata-based anomaly detection, metadata may be generated by processing electronic documents stored at a management platform to obtain various characteristics according to a multitude of pre-configured, updatable and customizable categories for the purposes of recognizing anomalies manifested in association with the categories. In many embodiments, a machine learning model, trained to establish triggering rules with respect to the categorized metadata, may be utilized to scan and benchmark activities in one or more data records within an exemplary computer platform/system (e.g., an account of a user of the exemplary computer platform/system). In some embodiments, by processing (e.g., scanning, digesting, parsing, etc.) the metadata instead of the content of the vast volume of the documents managed by the computer platform, the anomaly-detection technology herein may achieve various advantages, such as more comprehensive monitoring, higher detection accuracy, higher computing resource usage efficiency, higher network communication efficiency, and/or other benefits.

In at least some embodiments, as used herein, the terms “anomaly”, “anomalies” and alike may generally refer to cover data items, observations, activities, and/or events that are outliers, novelties, noise, deviations and/or exceptions that may raise suspicions by differing over an expected/estimated degree of a deviation from dominant number and/or dominant percent of data items, observations, and/or events. In some embodiments, the dominant number and/or dominant percent may vary depending on sample frequency and/or level of variability within a sample size of evaluating cases (e.g., data items, observations, and/or events). For example, in some embodiments, a data item, an observation, an activity, and/or an event may be recognized as being an anomaly when being different in unexpected extent over a fifty (50) percent of similar cases (e.g., data items, observations, and/or events).

In at least some embodiments, as used herein, the terms “account of the user”, “profile of the user”, “presence of the user”, “user account”, “user profile”, “user presence”, and alike may generally refer to and/or cover a computer space on a computer's hard drive, cloud, a network server, and/or virtual reality environment that is/are associated with user-related data (e.g., user-related documents) and/or user-related activities. In a variety of embodiments, the account of the user may include data stored in at least one particular location such as their external hard drive, or cloud storage accounts such as Google Drive™ and/or MS OneDrive™ accounts, for example. In at least some embodiments, as used herein, the terms “account of the user” and “account” may cover electronic storage and/or recordkeeping of user-related financial-related information (e.g., documents) within a computer system of, for example without limitation, a financial entity (e.g., bank) or a government-related entity (e.g., Internal Revenue Service).

Further, according to various other aspects, exemplary metadata-based anomaly-detection technology herein may automatically trigger, in response to the detected one or more incidents of anomalies, one or more actions associated with the account of the user, the profile of the user, the presence of the user, the user account, the user profile, the user presence, and the like. While actions involving user accounts are described by examples herein to illustrate various aspects of the disclosure, it should be understood that the disclosed technology pertains to any relevant application or process in which actions are performed in response to a detected anomaly, whether in a remedial manner, a preventive manner, and/or other usages.

Various embodiments disclosed herein may be implemented in connection with one or more entities that provide, maintain, manage, or otherwise offer any service to users and/or organizations. In doing so, such entities may collect, generate, record, obtain, or otherwise have access to the data pertaining to the users or organizations they service. In some embodiments, an exemplary entity may be a financial service entity that provides, maintains, manages, or otherwise offers financial services. Such financial service entity may be a bank, credit card issuer, or any other type of financial service entity that generates, provides, manages, and/or maintains financial service accounts that entail furnishing, maintaining documents or data relating to the financial service accounts of the user. Financial service accounts may include, for example, credit card accounts, bank accounts such as checking and/or savings accounts, reward or loyalty program accounts, debit account, and/or any other type of financial service account known to those skilled in the art.

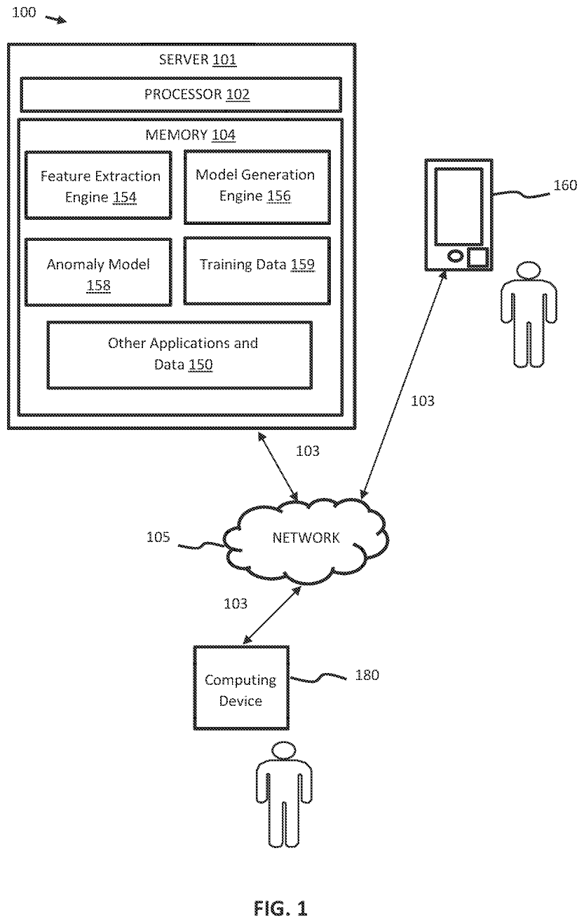

FIG. 1 depicts an exemplary system 100 associated with improved metadata-based anomaly detection, in accordance with one or more embodiments of the present disclosure. System 100 may include a server 101, a computing device 160, and a computing device 180, which may communicate 103 over a communication network 105. As illustrated herein, the computing device 160 and/or 180 may include a mobile device, other computing device or similar device with which a user of the computing device 160, a user of computing device 180 can communicate with the server 101.

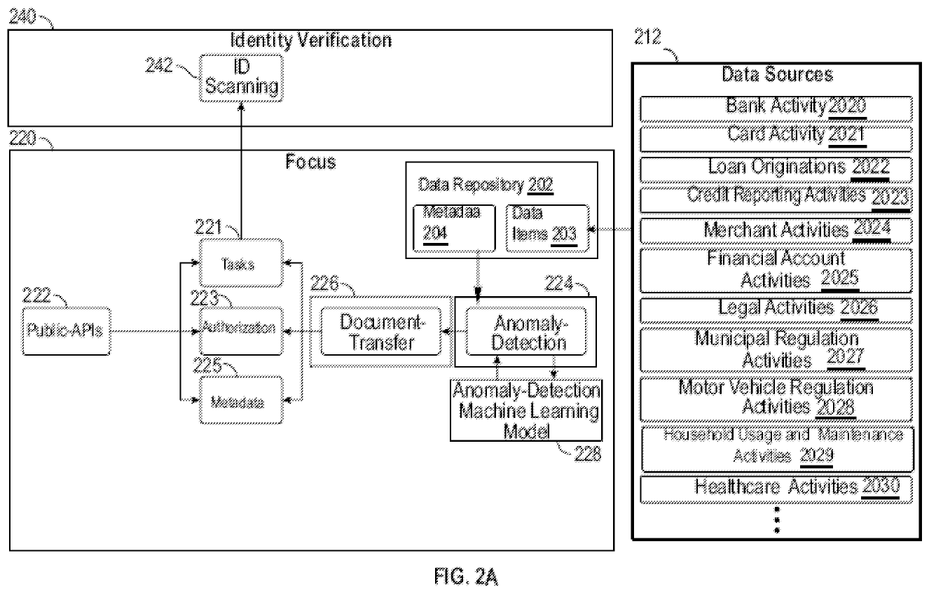

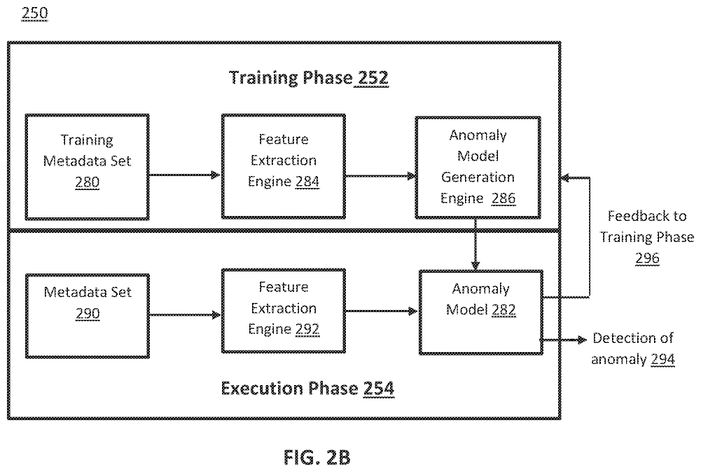

In some embodiments, a business or merchant associated with the server 101, e.g., a financial institution such as a credit card company that has issued a debit card or a credit card to the user, may generate or otherwise have access to a vast volume of documents or data items associated with a user who holds an account with the business or merchant. For instance, the server 101 may be configured with a document management platform (e.g., the platform 220 of FIG. 2A) to interface a multitude of data sources, process and manage a multitude of data items, and/or perform safeguarding procedures (e.g., transferal of documents, changes of permission to access user accounts and data items), in proactive, mitigative, and/or remedial fashions, among other things.

Referring to FIG. 1, server 101 may include at least one processor 102, and a memory 104, such as random-access memory (RAM), etc. In some embodiments, server 101 may be operated by the entity issuing a transaction card (e.g., credit card, debit card, etc.), by the merchant, and/or by any transaction processing entity. In some embodiments, the memory 104 may be configured to store computer-readable instructions or code that, when executed by processor 102 and/or other processors, may cause such processors to implement one or more functionalities of the metadata-based anomaly detection, as well as one or more functionalities in response to detected anomalies. As a non-limiting example, and as shown in the embodiment illustrated in FIG. 1, exemplary memory 104 may comprise a feature extraction engine 154, an anomaly model generation engine 156, an anomaly model 158, training data 159, and other applications and data 150.

In various embodiments, the server 101 may implement one or more aspects of various metadata-based anomaly detection herein, including those involving: (1) storing a plurality set of documents for a plurality of users, (2) generating a set of metadata items for each document in the set of documents associated with a user, (3) training a data anomaly-detection machine learning model having triggering rules conditioned on metadata and corresponding to one or more anomalies, (4) scanning the set of documents of the user to detect changes in the metadata, (6) determining whether there is an anomaly based on the anomaly-detection model and the changes in the metadata, and/or (7) automatically triggering one or more actions in response to the detected anomaly.

Computing devices 160 and 180, such as a PC, laptop, smartphone or other portable, wireless, wearable, or other electronic device, may include computing device circuitry. Computing device circuitry may include a computing device processor, memory such as RAM, computer-readable media, communication circuitry and interface, and/or any input and/or output device, such as a touchscreen display. The memory may store code that, when executed by the processor, may cause the processor to implement one or more aspects of allowing a user to perform anomaly detection triggered actions herein, including those involving: (1) receiving notification from the server 101 with regard to a detected anomaly, (2) confirming whether the notified occurrence of anomaly indeed is an anomaly and/or worthy of actions, (3) receiving action tasks transmitted from the server 101 in response to the detected anomaly, and/or (4) allowing the user to perform the required actions to complete or facilitate the completion of the action tasks.

Various embodiments associated with FIG. 1 and related disclosure herein solve a technical problem of providing improved detection of anomalies in the activities of users (e.g., such as activities in an account of the user, etc.). Some embodiments are implemented based on features and functionalities including metadata generation, data anomaly-detection model (e.g., anomaly model) generation (e.g., including training and retraining, etc.), as well as automated actions triggered by the detected anomalies. Further, in certain technological improvements that involve obtaining and classifying metadata associated with a set of the user's documents for processing into a plurality of pre-configured and yet modifiable categories of the disclosed technology, an exemplary machine learned anomaly detection model may be trained to establish the baseline conditions, e.g., to generate trigger rules regarding the categorized metadata, and/or to utilize scans of the user's documents to process changes in the metadata in connection with detecting anomalies. As such, instead of processing the content of a vast volume of documents associated with a large population of users, detecting anomalies based on metadata and machine learned model implementations herein may, inter alia, achieve improved computing resource usage efficiency as well as network communication efficiency, thereby leading to more comprehensive monitoring and more accurate, timely, and/or customized detection of anomalies.

While only one server 101, network 105, computing device 160, and computing device 180, are shown, it will be understood that system 100 may include more than one of any of these components. More generally, the components and arrangement of the components included in system 100 may vary. Thus, system 100 may include other components that perform or assist in the performance of one or more processes consistent with the disclosed embodiments. The following illustrates embodiments of the disclosure using examples of a document management platform that may be configured to implement various aspects of the metadata-based anomaly detection and actions triggered thereby.

FIG. 2A shows a schematic diagram of an exemplary metadata-based anomaly detection system involving various exemplary data sources, consistent with some aspects of the disclosed technology. According to the exemplary embodiment of FIG. 2A, the system 200 includes a platform 220 (e.g., Focus platform, etc.) and a data repository 202. As illustrated in this embodiment, upon detecting an anomaly by an anomaly detection engine 224, by use of an anomaly-detection machine learning model 228, in the user's account in association with the platform 220, the platform 220 may invoke a document transfer process 226 to perform various operations to allow an authenticated user (e.g., a transferee, etc.) to request and/or complete a process to transfer documents (e.g., assets, etc.) from the account of the user for whom the anomaly has been detected to the transferee. In many implementations, the document transfer process 226 may further invoke a tasks process 221, an authorization process 223, and/or a metadata process 225, along with access to an identification verifying process 240, to implement a secure and authenticated document transfer process. In some embodiments, one or more of the tasks process 221, authorization process 223, metadata process 225, anomaly detection engine 224, and document transfer process 226 may be implemented over an exemplary microservices architecture. This way, the functionalities of the platform 220 may be de-centralized into a collection of microservices to achieve one or more features such as scalability, stability, easy deployment, fault tolerance, among other benefits. Various suitable microservices architectures and technologies may be applicable herein, for example, without limitation, a Docker container service (Docker is a registered trademark of Docker, Inc., located in San Francisco, Calif., U.S.A.), a Docker Swarm Scheduler™ (Docker, Inc., San Francisco, Calif., U.S.A.), a Kubernetes Scheduler™ (The Linux Foundation, located in San Francisco, Calif., U.S.A.), an OpenShift Scheduler™ (RedHat, Inc. Raleigh, N.C., U.S.A.), a Prometheus monitor (Prometheus is a registered trademark of The Linux Foundation, located in San Francisco, Calif., U.S.A.), and the like. As shown in this example, the identification verifying process 240 may invoke an ID scanning process 242 to either manually or remotely scan an identification of an intended transferee, prior to authenticating the transferee for access to and completion of transferring documents thereto. In some embodiments, a set of public APIs may be provided at the platform 220 such that, one or more of the above-described processes may communicate with each other via the public APIs. In some implementations, such public APIs may be configured to provide an interface (e.g., a Representational state transfer (REST) interface, etc.) enabling communications between the components of the platform 220 and/or components external to the platform 220. Here, for example, such interface may be an interface in compliance with the REST standard, in one or more embodiments.

In the embodiment as shown in FIG. 2A, the system 200 may generate, collect, maintain, access, update or otherwise manage the data repository 202 as an in-system data collection. In a variety of embodiments, the platform 220 may also outsource for a third-party to provide the generation, collecting, maintenance, access, and updating with regard to a portion or the entire collection of the data available to the platform 220. According to various aspects of the disclosure, data items 203 included in the data repository 202 may include data that is in a variety of data format and/or sourced from a variety of sources. For example, data items 203 may include electronic documents containing texts, images, audio data, video data, virtual token data, hologram data, augmented reality data, virtual reality data, Internet of Things (IoT) data, and data descriptive of the content arranged thereinto. Electronic documents may be stored in various electronic file formats, including but not limited to, Microsoft Word, Microsoft Excel, Adobe PDF, HTML, PostScript, PDF, XML, JPEG, GIF, BMP, Flash, WAV, WebM, WMV, MPGE, suitable other binary and/or suitable plain-text file formats, etc. In some examples, an entire electronic document may be an image or video file yet with embedded textual information (e.g., metadata, etc.) capturing various information (e.g., title, timestamp, file size, author, source, location, etc.) with regard to the underlying data. In other examples, a composite document, for example, a web page, may have embedded therein a combination of data of various forms, as well as the respective descriptive data associated therewith. In one example, electronic documents may also contain references linking (e.g., hyperlinks, etc.) to other electronic documents.

Data items 203 may originate from various sources. As shown in this embodiment, non-limiting examples of data sources 212 include data generated by or pertaining to: credit reporting events (e.g., credit reporting agency activities 2023, etc.), merchant events (e.g., merchant activities 2024, etc.), financial account events (e.g., banking activities 2020, transaction card usage activities 2021, loan activities 2022, other financial account activities 2025, etc.), legal events (e.g., legal activities 2026, etc.), municipal regulation events (e.g., municipal regulation activities 2027, etc.), motor vehicle regulation events (e.g., motor vehicle regulation activities 2028, etc.), household usage and maintenance events (e.g., household usage and maintenance activities 2029, etc.), and healthcare events (healthcare activities 2030, etc.).

In one example, the data items 203 may, for a user, include electronic documents (including those scanned from physical documents) of: a bank statement, an investment account statement, an investment account tax statement, a credit card statement, a mortgage statement, a reverse mortgage statement, a home equity loan statement, a vehicle loan statement, a personal loan statement, a student loan statement, an insurance policy statement, a rent bill, a utility account statement, a landline phone account statement, a mobile phone account statement, a medical bill statement, a new credit card application, a new mortgage application, a new home equity loan application, a new car loan application, a new student loan application, a new personal loan application, a new insurance policy application, a new mobile phone account application, a new utility account application, a new loan application with the user as a cosigner, a new reverse mortgage application, a new credit line increasement application, a property tax statement, an association fee statement, a credit report, a new credit inquiry report, a collection notice, a postal change of address notice, a lease, a warrant, a service document, a policy report, a power of attorney document, a title transfer document, a title search document, a deed, a tax return document, a traffic ticket, a parking citation, a bounced check, a court order, a jury record, a court judgment, a legal complaint, an expired vehicle registration, an accident report, an insurance claim, a driver's license application, a new driver's license, a charity donation record, a club membership application, a club membership record, a frequent flyer program membership application, a frequent flyer program membership record, a vehicle rental program membership application, a vehicle rental program membership record, a zoning violation notice, an ordinance violation notice, a voter's registration, various types of goods/service purchasing invoices, and so on. As used herein, the term data item refers to any data elements or information that can be captured for storage at or access by, for example, the data repository 202. In various embodiments, the data items 203 may pertain to an individual user, a group of users, a business, an organization, a location, and the like.

Referring again to the exemplary embodiment of FIG. 2A, metadata 204 corresponding to data items 203 may also be stored in the data repository 202. Such metadata may be extracted, recognized, identified, derived, analyzed, provided, or otherwise obtained based on the data items 203 procured in or by the data repository 202. As used herein, the term metadata refers to any attribute of a data item or a set of data items. In some embodiments, a set of metadata items may comprise one or more data fields indicative of activities and/or states of activities associated with each set of documents and the respective user. For instance, a metadata item or a group of metadata items may indicate in a binary format that there is an anomaly as long as the metadata item(s) is detected (e.g., a large sum of cash withdrawal out of all the bank accounts, a large sum of purchasing outside of the state the user resides when other metadata indicates the user has not gone on a vacation (in relation to the baseline metadata being the user has been saving diligently over time, and the user does not incur out-of-state expenditure), and the like). In some embodiments, metadata may be extracted from the underlying data items which may already have their respective metadata generated and attached/embedded. In some embodiments, metadata may be recognized/identified using content recognition/identification techniques based on pre-configured policies, rules, and criteria. In some embodiments, metadata may also be recognized/identified using content recognition/identification techniques based on classifier models developed using machine learning technologies.

In some embodiments, data items 203 may be categorized into various categories and respective subcategories thereof. Taking an individual user for example, the data items relating to the user may be classified into categories of: finance, consumer expenditure, legal, healthcare and wellness, household and the like. For the finance category, subcategories may be further defined to include: credit reporting events, merchant events, financial account events, and the like. For the consumer expenditure category, subcategories may be further defined to include: grocery stores, department stores, airlines, hotels, dealerships, professional service fees, and the like. legal events, municipal regulation events, motor vehicle regulation events, household usage and maintenance events, and healthcare events. In some embodiments, a data item may be duplicated and included in multiple categories, or multiple subcategories of a same category, or multiple subcategories associated with different categories. For instance, a record of a late payment towards a credit card bill may appear in association with an affected credit report on the user.

According to various aspects of the disclosure, for data items of different categories, different metadata may be identified, recognized, derived or otherwise obtained using any suitable techniques, for example, based on white lists, flagged lists, rules, policies, user provided criteria, models (configured or machine learned or any combinations thereof). Such rules, policies, user provided criteria, models may as well be updated dynamically or otherwise customized according to various conditions such as timing factors, location factors, personal contextual factors, social contextual factors, other manually configured updates to metadata definitions, machine learned updates to metadata definitions, or any combination thereof. In some embodiments, the metadata definition may nevertheless be provided by a user, a custodian of a user, a legal representative of a user, or any other users or entities that may be in charge of safeguarding the wellbeing of a user against incidents, accidents, illness, and frauds. For example, a user may specify a set of white-list of categories for expenditure incurred by an elderly parent and a flagged-list of categories for such expenditure, based on the knowledge of the parent's spending habits and personal preferences. Exemplary white-list of categories may include the credit card transactions at neighborhood convenience stores, grocery stores, doctors' offices, pharmacies, and so on. Exemplary flagged-list of categories may include casino spending, virtual goods purchased in gaming apps, and so on.

In one example of a collection of data items containing reports from credit reporting agencies or credit bureau among many other information, the corresponding metadata may refer to an indication of an existence of: a new credit line (e.g., a loan or credit card account), a new credit inquiry, a missed payment, a utilization of credits above a threshold level, a new National Consumer Telecom & Utilities Exchange (NCTUE) account report, and the like.

In one example of a collection of data items containing documents from financial institutions and merchants among many other information, the corresponding metadata may refer to an indication of a new account created or in the process of being created/denied for the user. Non-limiting exemplary metadata may indicate that a new credit card account has been created, a new personal loan has been processed, a new loan application has been submitted, a new vehicle has been purchased, a new car loan has been processed, a new mortgage has been processed, a new home equity loan has been processed, a new insurance policy has been processed, a new mobile phone account has been created, a new utility account has been created, a new co-signing obligation has been processed for a new loan or an existing loan, a new reverse mortgage has been processed, and the like.

In this example, metadata may also refer to an indication of activities with existing accounts of the user. Non-limiting exemplary metadata may indicate that there is a credit line increase associated with a credit account of the user, a cash advance out of a credit card account, a balance transfer to another credit card account, an increase or decrease in the user's monthly spending (e.g., increase or decrease in the credit card's monthly statement), appearance of flagged merchant categories (both generally flagged or flagged individually for the user, e.g., casinos, convenience stores (e.g., lottery tickets, etc.), electronic stores, jewelry stores, airlines, hotels, etc.), a large amount of cash withdrawal, a high balance, a low balance, an overdrawn account, a change in payment pattern (e.g., no longer setting up an automatic payment or paying off the full balance, etc.), a late payment, a unpaid loan payment, unpaid utility bills, a new payee, a large amount of wire transfer, a large amount of ATM withdrawal, and the like.

Also in this example, non-limiting exemplary metadata may indicate that there is a new authorized user in affiliation, a change of address, a change of phone number, a change of email address, a change of beneficiary (e.g., on an insurance policy account, a retirement financial account, a request for replacement card, and the like. Further, non-limiting exemplary metadata may indicate a frequency of account logins, an account login from a new device, an account login from a new location, an account login from a new time zone, a request to reset the password to the account, an account login failure, a look-up of username, and the like.

In one example of a collection of data items containing documents pertaining to legal events among many other information, the corresponding metadata may refer to an indication of an existence of: a police report, a traffic ticket, an insurance claim, a criminal charge, a warrant, a lawsuit, a mirage license application, a divorce judgment, a power of attorney, a will, a real estate title transfer, a real estate title search, and the like.

In one example of a collection of data items containing documents from agencies at federal, state, municipal, and county level among many other information, the corresponding metadata may refer to an indication of an existence of a parking ticket (e.g., paid or unpaid), a traffic violation citation, an expired vehicle registration, a vehicle towing notice, a traffic accident (e.g., collisions, insurance damage report), a new vehicle registration, a new license registration, a new license restriction, voter's registration, and the like.

In one example of a collection of data items containing documents pertaining to household events (e.g., detected and recorded by technologies such as Internet of Things (IoT)) among many other information, the corresponding metadata may refer to an indication of lights not turned on or off, mail not collected, refrigeration not being opened or closed, dishwasher not being run for a long period of time, electricity usage running low, electricity usage running high, sewage usage running low, an exterior door not being opened or closed, grass exceeding a threshold height, newspapers or packages laid outside, garage door not being opened, cars not being moved out/in the garage, and the like.

In one example of a collection of data items containing documents pertaining to healthcare and wellness events (e.g., detected and recorded by technologies such as Internet of Things (IoT), collected from insurance companies, doctors, trainers) among many other information, the corresponding metadata may refer to an alert reminder for taking pills, an alert of unfilled prescriptions, a missed doctor's appointment, a missed dentist appointment, a missed optometrist appointment, a missed workout class, a falling accident, and the like.

According to various aspects of the disclosure, metadata information may be captured in the form of a binary value, other numerical value, text, and/or any other suitable format. In some embodiments, metadata may be generated using a machine learning model trained with the data items relating to a general population, a group of individual users, an individual user, or a combination thereof. In many implementations, the machine learning model may be configured in a hierarchy such that data items are first classified into their respective categories, and in turn, based on respective metadata identification models trained with the data items in the respective category, metadata may be extracted or otherwise obtained. For example, a text based, image based, audio based, video based document classifier model may be used to classify input data items into a predefined set of categories, including, e.g., financial account events, merchant events, credit reporting, legal events, municipal, state, motor vehicle and other agency events, household usage and maintenance events, healthcare events, and other categories. As such, only the data items belonging to categories of interest (categories of interest may be updated dynamically as well) need to be processed by the metadata identification model in the next stage of the hierarchical approach to extract metadata information with higher efficiency, accuracy, and specific configurability.

FIG. 2B is a block diagram illustrating an exemplary system involving a machine learning based anomaly model, consistent with various aspects of the disclosure. As shown in FIG. 2B, system 250 includes a training phase 252 which trains a machine learning anomaly model and an execution phase 254 which uses the machine learning anomaly model to detect anomalies in activities of a user associated with a document management platform.

As shown herein, the training phase 252 builds a machine learning anomaly model 282 for a collection of metadata items. A collection of metadata items is a collection of metadata generated based on or pertaining to various data items accessible to the system 250. In some embodiments, a collection of metadata items may be associated with a particular user, a particular group of users, a particular service entity, and the like. The training phase 252 may utilize a training metadata dataset 280, a feature extraction engine 284, and an anomaly model generation engine 286.

The training metadata dataset 280 is a corpus of metadata records obtained or otherwise identified or recognized with regard to a multitude of data, for example, those obtained from various data sources illustrated in FIG. 2A. The training dataset 280 may comprise training data related to the general population of users, a particular user (e.g., user's account), or a group of users (e.g., users' accounts). The training dataset 280 may be generated via the platform 220 of FIG. 2A, or obtained from a third party which warehouses and services user data for various purposes such as machine learned model generation. In such cases, the training metadata dataset 280 may be stored as a cloud or web service that is accessible to various parties through online transactions over a network.

Referring to the exemplary embodiment of FIG. 2B, the feature extraction engine 284 may be configured to extract features from the metadata training set to train the anomaly model 282. In some embodiments, the anomaly model 282 may be trained in a supervised manner, a semi supervised manner, and/or an unsupervised manner. In some embodiments, the feature extraction engine 284 may transform the features into feature vectors with, for example, an annotation and/or a software tag that indicates whether a feature vector corresponds to an anomaly or not. In some embodiments, the feature vector represents one or more changes in respective metadata. The feature vectors are then used to train and test the anomaly model to detect the likelihood or probability that an anomaly occurs in the activities of a user. In some embodiments, the feature vectors may be partitioned into two subsets such that one subset is used to train the anomaly model and the second subset is used to test the anomaly model. In some implementations, the anomaly model is trained and tested repeatedly until the anomaly model can perform anomaly detection with a pre-configured confidence and error tolerance.

In some embodiments, the anomaly model 282 may be a classification model. Here, for example, such classification model may be utilized to predict a discrete label for each input scan of a user's metadata. Various classification models, such as models characterized as, without limitation, discrete tree classifiers, random tree classifiers, neural networks, support vector machine, naive Bayes classifiers, and the like, may be generated as an anomaly model. In some embodiments, a gradient boost classification model is generated. Gradient boost classification is able to predict a probability with each label which enables the risk levels to be ranked. In some embodiments, the anomaly model 282 may comprise one or more cascade-based models for detecting anomalies via multiple stages. Each stage may be associated with a stage specific model and a stage specific detection threshold such as risk levels. More details of the cascade-based models are described below. In some embodiments, a detection threshold may be set as at least one statistical standard deviation from a mean value. In some embodiments, a detection threshold may be set as at least two statistical standard deviations from a mean value. In some embodiments, a detection threshold may be set as at least three statistical standard deviations from a mean value. In some embodiments, a detection threshold may be an arbitrary value set by the user.

In the illustrative embodiment of FIG. 2B, the execution phase 254 may apply the anomaly model 282 to a set of metadata 290 scanned from data items relating to a user's account. In some embodiments, the feature extraction engine 292 may generate feature vectors having features that represent different manifestations of anomalies in the set of metadata. The anomaly model 282 then uses the feature vectors to assign a risk level to the set of metadata. In some embodiments, the anomaly model 282 may draw a conclusion, based on the risk level exceeding a pre-configured threshold level or a machine learned threshold level, that there is occurrence of an anomaly in the set of metadata 290 to output a detection of an anomaly 294. In some embodiments, the anomaly model 282 may further associate a rationale for the anomaly detected conclusion. A rationale supporting the determination that there has been an anomaly in the user′ activities may include a single feature in the feature vector that is dispositive of the detection (e.g., given a particular context or setting of the user), a combination of features, or an ordered or otherwise structured combination of features that contribute to the conclusion of a detected anomaly. In some embodiments, the rationale and a verification result of the detected anomaly is fed back 296 to the training phase 252 to retrain the anomaly model 282.

In various embodiments, the training metadata dataset 280 may include metadata items annotated with a baseline status to indicate an absence of an anomaly associated with the general population, a particular user (e.g., user account, etc.), or a group of users (e.g., users' account, etc.). A baseline status indicates the opposite of a presence of an anomaly in the activities of the user. In some embodiments, a range of metadata items may be labeled as being associated with a baseline status when anomalies lie outside of a range of normal conditions and status. When the metadata items in the training dataset indicate an absence of an anomaly for an individual user or a group of users having similar characteristics, the anomaly model 282 may be trained to require information relating to the particular characteristics of the individual user or group of users as input in order to output a conclusion with regard to detecting the absence of anomalies. Alternatively, the anomaly model 282 may also be generated and trained as a detection model per user, or per a group of users.

In some embodiments, a single metadata item in the training dataset 280 may be annotated to indicate an occurrence of an anomaly for the general population, a particular user (e.g., user account), or a group of users (users' accounts). For instance, a metadata item indicating that the funds in all the bank accounts of the user have been withdrawn in their entirety may be a dispositive manifestation of an anomaly in the user's life. When a single metadata item is dispositive of an occurrence of an anomaly for the general population (e.g., every user associated with the document management platform), the anomaly model 282 may be trained to scan the data items correspond to the categories of the metadata item with a priority in order to detect anomalies with a higher efficiency and accuracy. When a single metadata item is dispositive of an occurrence of an anomaly for an individual user or a group of users having similar characteristics, the anomaly model 282 may be trained to require information relating to the particular characteristics of the individual user or group of users as input in order to output a conclusion with regard to detecting anomalies. Alternatively, the anomaly model 282 may also be generated and trained as a detection model per user, or per a group of users.

In some embodiments, a multi-dimensional metadata feature space may be defined to represent the set of metadata indicating an anomaly in activities of the user. The multi-dimensional feature space may be formed by a set of binary values or other numeric values or text features associated with the categories of metadata representing how an anomaly is manifested in the metadata of multiple categories. Here, various implementations may have a set of metadata items in the training dataset 280 be annotated to indicate an occurrence of an anomaly for the general population, a particular user (e.g., user account, etc.), or a group of users (e.g., users' accounts, etc.). In some embodiments, since all the metadata items in the set are required to indicate an occurrence of an anomaly, the anomaly model 282 may be trained to recognize those metadata items in any order, as long as it is confirmed that all the metadata items in the set are present. In a variety of embodiments, a subset of the metadata item in the set is afforded with a higher priority for recognizing than that of another subset of the metadata in the set. In many implementations, the set of metadata items may be further clustered into a hierarchical structure such that the anomaly model 282 may be trained to scan for a subset of metadata in the set first, then a second subset in the set, and so forth. For example, the anomaly model 282 may be trained to scan a first subset of categories of metadata to draw a first conclusion. It is only when the first conclusion is affirmative with regard to an occurrence of an anomaly that the anomaly model 282 further scans a second subset of categories of the metadata to draw a second conclusion, and so forth. In other words, the anomaly model 282 may be trained to scan the vast volumes of metadata in a machine learned or configured prioritized order, further enhancing system efficiencies. In many implementations, the set of metadata items is clustered into a graph such that the anomaly model 282 may be trained to recognize the different categories of metadata associated with an anomaly in one or more branching paths included in the graph of metadata items. For example, the anomaly model 282 may be trained to scan a first node of category of metadata, then a second node of category of metadata, depending on a first conclusion made with regard to the first node. If a second conclusion is made with regard to the first node, the anomaly model 282 may be trained to scan a different second node of category of metadata, and so forth. In such cases, the training data may be further annotated to indicate the relationship and/or orders among the metadata items. Similarly, the anomaly model 282 may be trained to require information relating to particular characteristics of an individual user or group of users as input in order to output a conclusion with regard to detecting anomalies. Alternatively, the anomaly model 282 may also be generated and trained as a detection model per user, or per a group of users.

In many implementations, where there is an order in analyzing metadata that may lead to a conclusion of an occurrence of an anomaly, cascade-based models may be utilized to orchestrate the anomaly model 282 into one or more cascade-based models. For example, a cascade-model based anomaly model 282 may be configured with a plurality of stages including a first stage associated with a first model and a first detection threshold, and a second stage associated with a second model and a second detection threshold. An exemplary first stage may include a first model trained to detect anomalies based on a set of prioritized metadata items and the features. Here, the cascade-model progresses into the second stage to apply the second model to a second subset of the metadata only when an anomaly is detected in the first stage by applying the first model to a first subset of the metadata. In some embodiments, the number of stages, the model and detection threshold associated with the stages may be configured based on the characteristics of a particular user, or a group of users. In some embodiments, the configuration of the number of stages, the model and detection threshold associated with the stages may be trained and/or retrained using various training datasets.

In some embodiments, categories of metadata in the training dataset may be designated with respective weights to indicate the relative importance of the occurrence of the activities underlying the metadata. As such, the anomaly model 282 may be trained to determine a risk level associated with a detection of an anomaly based on the weighting factors associated with the underlying metadata items. For example, for metadata associated with the category of activities of an existing financial account, metadata indicating an ATM withdrawal of a relatively large sum of cash may be designated with a weight less than that metadata indicating a new home equity loan/reverse mortgage loan, for a user who is a senior citizen. Weights assigned to various categories of metadata may be configured based on any suitable rules, policies, criteria, models (manually configured, machine learned, or a combination thereof). In some embodiments, such weights may also be conditioned based on dynamic context such as timing factors, location factors, life event factors, other items of metadata, and/or user overwriting input. Using the above-illustrated example again, when metadata indicating that a modest amount of ATM withdrawal in a non-resident state, together with metadata indicating that the household is in regular usage in terms of utilities, mail collection, appliance usage, etc. (e.g., the user has not traveled outstate), weight afforded to the metadata associated with the ATM withdrawal may be increased to a higher value. In some embodiments, weights associated with categorized metadata may also be adjusted based on demographic information of the user. For instance, for an elderly parent living alone, metadata associated with activities in the sectors of financial account, household usage and maintenance, as well as healthcare may be deemed of higher importance and therefore designated with a larger weight value. On the other hand, for a college student living in a dorm, metadata associated with the sectors of abnormal expenditure and legal events may be deemed of higher importance and therefore designated with a larger weight value. In some embodiments, a weight value respective to a category of metadata may be designated as zero based on information including, for example, demographic data, location data, to indicate that such metadata is not to be extracted or otherwise identified. In some embodiments, the weights associated with metadata items may also be adjusted based on machine learned knowledge with regard to, for example, at what context (e.g., time, location, other metadata, etc.) a specific weight accurately manifest the risk level associated with a metadata item.

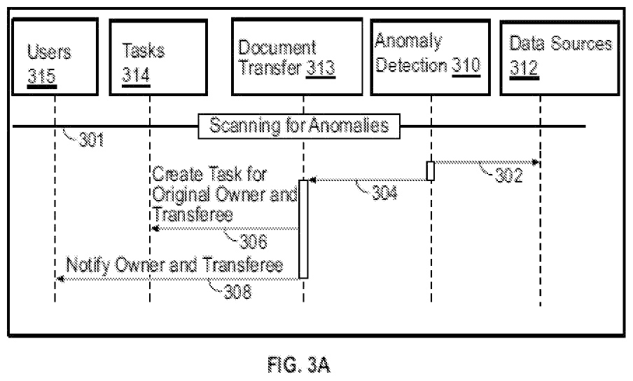

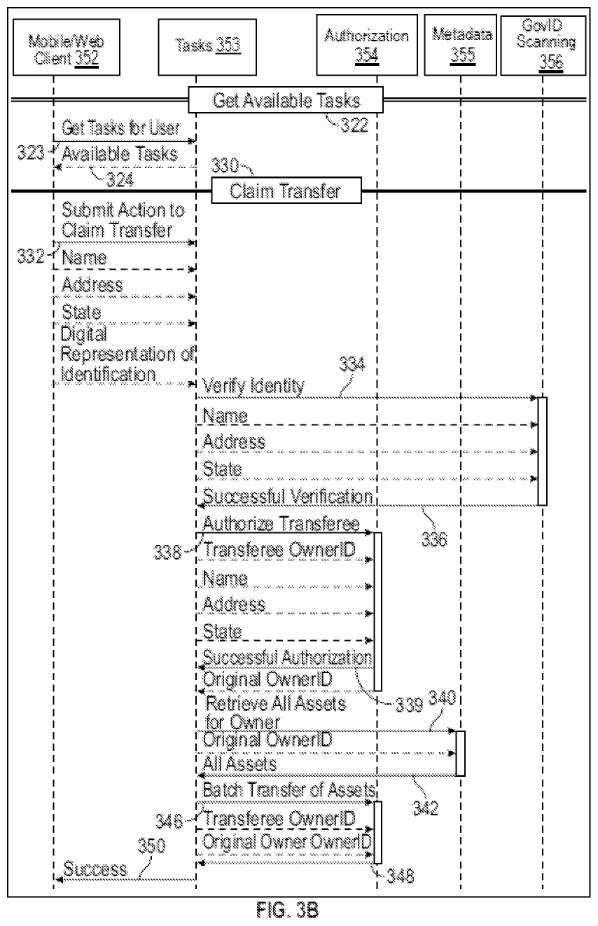

In some embodiments, the anomaly model 282 may be retrained based on the confirmation of a detection of an anomaly and/or a false positive detection of an anomaly. As described below in the example illustrated with reference to FIG. 3B, various actions may be triggered upon a determination of one or more anomalies in activities of the user. In some embodiments, the detected anomaly is further verified manually or otherwise confirmed prior to or during the triggering and processing of actions responsive to the anomaly detections. In many implementations, a security token may be generated as an indicator to signal that the detected anomaly is not false positive and the appropriate actions are triggered to address and/or remedy the situation in protection of the user. In some embodiments, the anomaly model 282 may be retrained based on updates and/or changes to the training dataset. For example, depending on a user or a group of users' newly developed characteristics (e.g., an elderly parent who used to living alone has moved into a nursing home, a user who has relocated from a metropolitan area to a rural area of another state), correspondingly updated training dataset may be obtained and utilized to retrain the anomaly model to adjust its knowledge and intelligence with regard to anomaly detection.

In some embodiments, the data repository 202 may be hosted and serviced by a third party. In this case, the system 200 may be configured with accessibility to the data repository 202, and/or with capabilities to instruct the third party in terms of what data items to procure and how to generate metadata respectively. In some embodiments, the data repository 202 may be partitioned into a data item portion and a metadata portion such that, for example, the system 200 may be configured to generate the metadata portion based on the data item portion, internally to afford more control over how to define and identify metadata. In this case, the data repository 202 may also be configured to receive data items from multiple systems that process data items into metadata according to their own or otherwise specified in-house rules, policies and models. In another scenario, the data repository 202 may be tasked with a relatively simple processing to generate an initial set of metadata stored along with the respective data items. In this case, the system 200 may be configured to either include the initial set of metadata and/or perform metadata identification further based on the initial set of metadata.

In some embodiments, the anomaly-detection machine learning model 228 may be hosted and serviced by a third party, entirely or in a partial manner as well. In the scenario where the anomaly-detection machine learning model 228 is partially serviced by the third party, a hierarchy may be accordingly implemented between the portion of anomaly model such that the lower level processing can be performed via the machine learning model at the third party; while the upper level processing can be performed via the machine learning model at the system 200. In some embodiments, the system 200 may also be configured to outsource the machine learning for detection based on the categories of data items and/or categories of metadata. For instance, the system 200 may be configured to communicate with a third party service that specialize in home security and surveillance services to specify and obtain metadata relating to a user's household usage and maintenance activities.

Further, it should be appreciated that one or more of the illustrative components/modules/engines in FIGS. 2A-2B may include other components, sub-components, modules, sub-modules, and devices commonly found in a communication/computing system, which are not discussed above with reference to metadata-based anomaly detection system and not discussed herein for clarity of the description. Additionally, in some embodiments, one or more of the illustrative components/modules/engines can form a portion of another component/module/engine and/or one or more of the illustrative components/modules can be independent of one another.

FIGS. 3A-3B are schematic diagrams of certain illustrative aspects of exemplary anomaly detection based on metadata, consistent with exemplary aspects of certain embodiments of the present disclosure. As shown in this example, with a trained anomaly model, a series of interactions are enabled to detect anomalies and act upon the detected anomalies. Here, a scan 301 is performed for all the documents associated with a user and stored at a platform. As a result of the scanning, the previously generated metadata associated with the documents may be updated, new metadata may be generated as well. Based on the scanning results, an anomaly detection entity 310 (e.g., a module, an engine, a service) may be configured to apply 302 such scanned changes in the metadata set of the user's documents to an anomaly model (not shown) to determine whether there is an occurrence of an anomaly in activities of the user. In the example illustrated herein, upon a detected anomaly, the anomaly detection entity 310 may be configured to communicate 304 with a document transfer entity 313 to initiate actions to be taken in response to the detected anomaly. Here, the document transfer entity 313 may create 306 one or more tasks 314 for the user (e.g., the account owner for which the anomaly is detected), and/or another user during the course of responding to the detected anomaly. Another user may be a pre-authorized user (e.g., a transferee, a legal custodian, a service entity, and the like). In turn, the document transfer entity 313 may further notify 308 one or both of the account owner user and the another user (e.g., users 315) of one or both of: the detected anomaly, and/or the one or more tasks created in response to the detected anomaly. In some embodiments, the one or more tasks triggered in response to a detected anomaly may be processed by a third party alone, or in cooperation with the document transfer entity 313. In some embodiments, one or more of the document transfer entity 313, tasks 314, and anomaly detection entity 310 may be implemented over a Microservices architecture.

Now turning to FIG. 3B, a series of interactions between a mobile/web client 352 and various processes involved in the actions triggered by the detected anomaly is illustrated as an non-limiting example. Here, the interactions follow the interactions illustrated in FIG. 3A, in which the account owner user and the transferee user are notified of the one or more tasks created in response to the detected anomaly. At 322, a user at the mobile/web client 352 may retrieve the one or more tasks created in response to the detected anomaly. In many implementations, the user at the mobile/web client 352 may submit 323 a request to a task process 353 (e.g., task generation module, task assignment engine) to obtain the one or more tasks created for the user and in association with the particular incident of a detected anomaly. In return, the user at the mobile/web client 352 may receive 324 a list of one or more such tasks assigned to the requesting user. For example, a transferee user may receive a list of tasks different than that an account owner user may receive. In many implementations, only a transferee user may receive a list of tasks based on pre-configured settings of the account owner user and the transferee user. In such cases, the account owner user may receive an indication that a designated transferee is acting upon a detected anomaly, without the specifics or details regarding the tasks created to address the anomaly detected to provide additional security measures to the account owner user.

In the example illustrated in FIG. 3B, once the user at the mobile/web client 352 receives a list of the one or more tasks generated to address the detected anomaly, a process of claim transfer 330 may be triggered into action. Here, via the mobile/web client 352, the user may submit 332 to the tasks process 353 the information required to further process the claim transfer. In this example, the user transmits information including a name, an address, a residing state, and a digital version of an identification (e.g., e-copy of an ID card, a passport) to the tasks process 353. In turn, and in receipt of the information submitted from the user, the tasks process 353 may perform a process to verify 334 the identity of the user based on the received information (e.g., a name, an address, residing state). In various implementations, identifications such as a government issued ID card (e.g., a state issued ID, DMV's issued driver's license, passport) may be verified via various techniques (e.g., an app, a mobile web browser, a web based application) executing on a mobile device of the user, or any computing device accessible to the user to verify the authenticity of the identifications. In some embodiments, the user's identity is further matched with the information specified on-file for the purposes of document transfer. In this example, a government ID scanning process 356 may be invoked to verify the identity of the user using the information submitted in response to the launched claim transfer. Upon a successful verification 336 returned from the scanning process 356, the tasks process 353 may progress to authorizing 338 the user as the transferee with an authorization process 354. In doing so, information including the transferee's owner ID (e.g., account information), a name, an address, a residing state, and the like is communicated to the authorization process 354. Upon a successful authorization 339 of the user, the authorization process 354 may communicate to the tasks process 353 the account owner's information (e.g., original account owner's ID, etc.). At this point, with the knowledge of the original account owner's information, the tasks process 353 may further progress to retrieving, for example, all or part of the metadata associated with assets owned by the original user 340, from a metadata repository 355 (e.g., repository service). In doing so, the tasks process 353 may initiate a batch transfer of ownership 346 (or a batch grant of privileges) in the authorization process 354 allowing a user to access assets owned by the original user. In the representative embodiment, here, for example, the illustrative tasks process 353 may implement such processing 346 to batch transfer the assets by sending one or both of the transferee's ID and/or the original account owner's ID to the authorization process 354, and receive 348 a confirmation that the assets have been transferred in batch successfully, e.g., indicating to the task process 353 that the transfer of ownership conducted within the authorization process was successful. Lastly, given the confirmation from the authorization process 354, the tasks process 353 may conclude the claim transfer by sending 350 to the mobile/web client 352 of the user to communicate that the transfer process has been successful completed. In some scenarios, when the tasks process 353 encounters a stop point during the authorized transfer for some unforeseen reason (e.g., extra security required, manual authorization required), a corresponding message (not shown) may be sent to the user instead. In some exemplary embodiments, one or more of the tasks process 353, authorization process 354, and metadata repository 355 may be implemented over an exemplary microservices architecture.

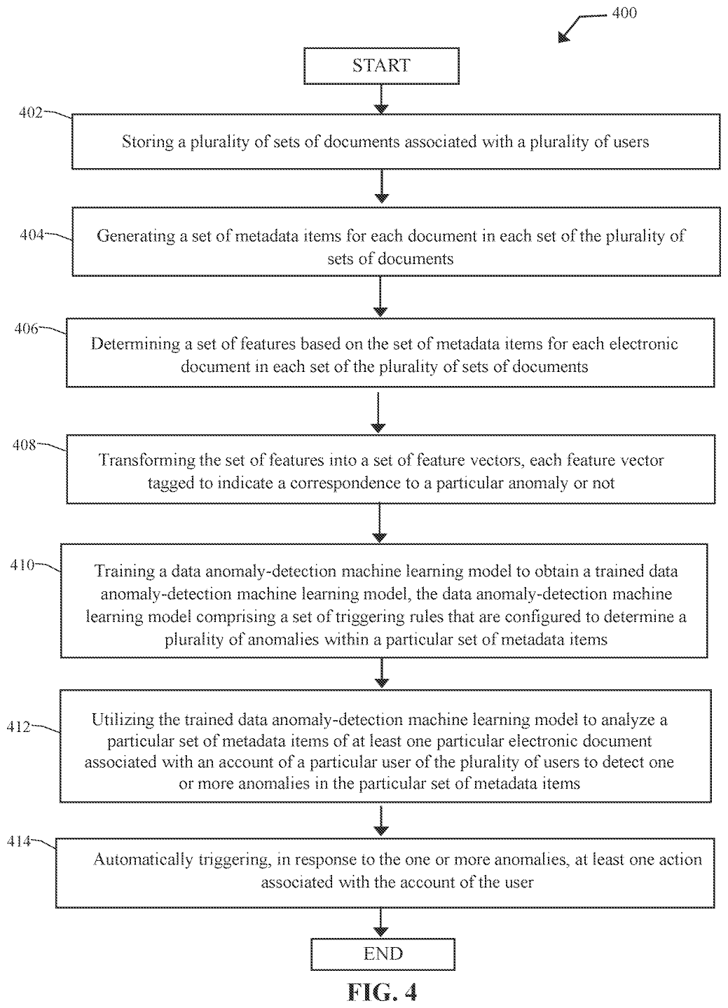

FIG. 4 is a flowchart illustrating one exemplary process 400 related to metadata-based anomaly detection, consistent with exemplary aspects of certain embodiments of the present disclosure. Referring to FIG. 4, an illustrative process 400 related to metadata-based anomaly detection, may comprise: storing a plurality of sets of electronic documents associated with a plurality of users, at 402; generating a set of metadata items for each electronic document in each set of the plurality of sets of documents, at 404; determining a set of features based on the set of metadata items for each electronic document in each set of the plurality of sets of documents, at 406; transforming the set of features into a set of feature vectors, each feature vector tagged to indicate a correspondence to a particular anomaly or not, at 408; training, based at least in part on the set of features_vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items, at 410; utilizing the trained data anomaly-detection machine learning model to analyze a particular set of metadata items of at least one particular electronic document associated with an account of a particular user of the plurality of users to detect one or more anomalies in the particular set of metadata items, at 412; and automatically triggering, in response to the one or more anomalies, one or more actions associated with the account of the user, at 414. Further, such illustrative process 400 may be carried out, in whole or in part, via or in conjunction with the server 101 of FIG. 1, the platform 220 of FIG. 2A, and/or the system 250 of FIG. 2B. Any suitable machine-learning models may be utilized for training with any suitable training data to establish and/or update any suitable rules defining the triggering conditions for anomalies in the user's activities. In various implementations, such machine-learning process may be supervised, unsupervised, or a combination thereof. In some embodiments, such machine-learning models may comprise a statistical model, a mathematical model, a Bayesian dependency model, a naive Bayesian classifier, a Support Vector Machine (SVMs), a neural network, and/or a Hidden Markov Model.

In some embodiments, the data anomaly-detection machine learning model may be trained for each of the pre-configured and updatable categories of events as described above with connection to FIG. 2A. For example, for each of the categories of data pertaining to financial account events, merchant events, credit reporting, legal events, municipal, state, motor vehicle and other agency events, household usage and maintenance events, healthcare events, respective anomaly-detection model may be established, trained and re-trained to capture the respective triggering patterns manifested in the changes in metadata associated with the categorized data items. In some embodiments, one or more of the category-specific anomaly-detection models may be configured as the one or more frontline anomaly-detection models, which may be applied prior to other anomaly-detection models being utilized to scan for triggering conditions in metadata of other categories. Here, for example, an anomaly-detection model trained with respect to the financial account events may be configured to trigger downstream actions upon detecting that a sum of cash withdrawal exceeds a pre-configured and/or machine-learned threshold.

In some embodiments, the anomaly-detection models may be trained as one or more orchestrating model for the purposes of prioritizing and channeling the usage of anomaly-detection models trained with categories specific training data. For example, a machine learning model may be trained to determine which anomaly-detection models are the frontline models for use to scan users' data, which anomaly-detection models are the second ones in line, independently and/or in response to the scanning results predicted by the frontline models. In other words, the orchestrating model may be trained to oversee the prioritize, based on various contexts of the user(s), history of the user(s), etc., to apply a multitude of anomaly-detection models to volumes of data for scanning. This way, despite the vast amount of data accumulated and ever-expanding on or otherwise available to the platform, the anomaly-detection models can be applied, updated, and retrained effectively and efficiently to capture, foresee anomalies manifested in users' accounts to various extent.

In some embodiments, the triggering rules learned by the anomaly-detection models may include atomic rules. For example, a triggering rule learned by the anomaly-detection models may comprise a rule specifying that any transfer of fund to another account not previously authorized and exceeding a pre-configured amount triggers a downstream action, a rule specifying that any new line of credits (e.g., loan, mortgage, reverse mortgage, credit line increase, etc.) regardless of the amount approved or requested triggers a downstream action, a rule specifying that any activity that opens an new account (e.g., utility account, phone account, bank account, etc.) triggers a downstream action, a rule specifying that any payment activity related to flagged entities (e.g., casino, jewelry stores, gaming app, hotels, etc.) triggers a downstream action, and the like. In many implementations, a downstream action may include, for example, transferring of electronic documents of the set of electronic documents of the user.

In some embodiments, the triggering rules learned by the anomaly-detection models may include chain reaction rules. In other words, such a triggering rule may specify a downstream action as to apply one or more particular anomaly-detection models as the next scanning. In some embodiments, such chain reaction rules may be specified without any anomaly being detected in the first place. For example, for a particular user or group of users, when no anomaly is detected upon scanning with the model specifically trained with respect to the financial events, always perform a scan against the model trained for the healthcare and/or household maintenance categories. In some embodiments, the recursive triggering rules (e.g., the triggering rules embedded as part of another triggering rule) may be conditioned on the detection of an anomaly. For example, a triggering rule learned by the anomaly-detection models may comprise a rule specifying that upon detecting an executed power of attorney document, applying the models specific to the financial merchant events, credit reporting, legal events, municipal, state, motor vehicle and other agency events with higher priority and/or higher frequency. According to some implementations, a triggering rule learned by the anomaly-detection models may comprise a rule specifying that upon detecting a missed physician's appointment, applying the models specific to the household usage and maintenance events and merchant events with higher priority and/or frequency.

According to the illustrative embodiment shown in FIG. 4, process 400 may include, at 402, a step of storing a plurality of sets of electronic documents associated with a plurality of users on a platform. Such platform may comprise any suitable system that procures or otherwise has access to various electronic documents associated with the plurality of users. In many implementations, the platform may be implemented by the platform 220 of FIG. 2A. With regard to various aspects of the disclosure, each set of the plurality of sets of electronic documents may correspond to an account of a user of the plurality of users having respective accounts, profiles, presences, or the like in association with the platform. In some embodiments, electronic documents of the plurality of sets of electronic documents may comprise any data relating to the user's activities. For instance, an electronic document may comprise one or more of: textual data; imagery data; audio data; video data; virtual token data; hologram data; augmented reality data; virtual reality data; and/or Internet of Things (IoT) data.

According to various embodiments of the disclosure, the activities of the user may comprise: credit reporting events, merchant events, financial account events, legal events, municipal regulation events, motor vehicle regulation events, household usage and maintenance events, and healthcare events. Specifically, the financial account events may comprise one or more new account events and one or existing account events. The tone or more new account events may comprise a new credit card event, a new personal loan event, a new loan application event, a new car purchase event, a new car loan event, a new mortgage event, a new insurance policy event, a new mobile phone account event, a new utility account event, a new co-signor on a loan event, and a new reverse mortgage event. the one or more existing account events may comprise: a credit card event, a payment event, a purchase event, an identity event, an authentication event, a balance event, and a ownership event.

The process 400 may include, at 404, a step of generating a set of metadata items for each document in each set of the plurality of sets of electronic documents. Various embodiments herein may be configured such that the set of metadata items may comprise one or more data fields indicative of states of activities associated with each set of electronic documents.

The process 400 may include, at 406, a step of determining a set of features based on the set of metadata items for each document in each set of the plurality of sets of documents; and at 408, a step of transforming the set of features into a set of feature vectors, each feature vector tagged to indicate a correspondence to a particular anomaly or not. In various embodiments, the set of features may be determined, transformed, and/or tagged utilizing the feature extraction engine 284 of FIG. 2B.

The process 400 may include, at 410, a step of training, based at least in part on the set of features_vectors, a data anomaly-detection machine learning model to obtain a trained data anomaly-detection machine learning model, the data anomaly-detection model comprising a set of triggering rules that are configured to determine a plurality of anomalies within a particular set of metadata items. In various embodiments, the data anomaly-detection machine learning model may be trained based on one or both of: historical changes in the set of metadata items associated with the account of the user, and/or historical changes in metadata items associated with accounts of a group of users. In some implementations, the data anomaly-detection machine learning model may be trained with feature vectors associated with a set of metadata items of historical electronic documents.

In some embodiments, the data anomaly-detection machine learning model may comprise one or more cascade-based models. In many implementations, a cascade-model of the one or more cascade-models may comprise a plurality of stages including a first stage associated with a first model and a first detection threshold, and a second stage associated with a second model and a second detection threshold. As such, the cascade-model may progress into the second stage to apply the second model to a second subset of the metadata only when an anomaly is detected in the first stage by applying the first model to a first subset of the metadata.

The process 400 may include, at 412, a step of utilizing the trained data anomaly-detection machine learning model to analyze a particular set of metadata items of at least one particular electronic document associated with an account of a particular user of the plurality of users to detect one or more anomalies in the particular set of metadata items. In some embodiments, the data anomaly detection machine learning model may detect one or more anomalies as long as there is an occurrence of a metadata item in the particular set of metadata items. In other words, the data anomaly detection machine learning model may detect one or more anomalies in the particular set of metadata items without the reference to a past condition and/or a baseline conditions associated therewith.

In some embodiments, step 412 may further comprise scanning the particular set of metadata items of the at least one particular electronic document associated with the account of the particular user of the plurality of users to detect one or more changes in the particular set of metadata items. In various embodiments, such scanning may be performed in any suitable manner or order. In some embodiments, the scanning may be performed in completion such that all of the resultant changes in the metadata items are provided to the data anomaly detection model for processing. In some embodiments, the scanning may be performed in phased operations such that categories of metadata of priority may be first checked upon, after which the resultant data is immediately provided to the data anomaly detection model without waiting for the rest of the metadata being scanned. This way, the scanning may be configured to unearth metadata changes in a prioritized manner, especially given that, one or more types of changes in metadata of specific categories may be dispositive for the data anomaly detection model to conclude there is an occurrence of an anomaly. Accordingly, in some embodiments, when the data anomaly detection model determines that there are one or more anomalies in the account of the user based on the partial scan results, the scanning for the set of documents associated with the user may conclude without incurring more computing resources, thereby achieving the monitoring of a larger population of users' activities in a real time, or near real time fashion.

In some embodiments, the detecting of one or more anomalies in the particular set of metadata items may comprise determining whether a risk level associated with the one or more anomalies exceeds a threshold value. As illustrated in the example above, some embodiments may be configured such that the threshold value may be determined by the data anomaly-detection machine learning model.

The process 400 may include, at 414, a step of automatically triggering, in response to the one or more anomalies, one or more actions associated with the account of the user. In some embodiments, the one or more actions triggered may include generating a security token in response to the one or more anomalies, and initiating the automatic triggering of the one or more actions associated with the account of the user based on the security token. A security token may comprise any suitable digital content that may securely indicate that the sender of the security token is authenticated to perform the requested data or engage the requested actions. In one example, the one or more actions associated with the account of the user may comprise transferring of documents of the set of documents of the user. In some embodiments, the one more actions associated with the account of the user may comprise one or more of: modifying an access permission to the account associated with the user, delegating another entity to monitor the account of the user, and/or transferring assets associated with the account of the user to an authenticated transferee. In many implementations, the automatically triggering the one or more actions associated with the account of the user may comprise a series of operations. By way of non-limiting examples, the operations may include: generating, by the one or more processors, one or more tasks in response to one or more anomalies; notifying, by the one or more processors, one or more of: the user, the another entity, and the authenticated transferee; transmitting, by the one or more processors and in response to a confirmation the one or more of the user, the another entity and the authenticated transferee, the one or more tasks to the one or more of the user, the another entity and the authenticated transferee who sends the confirmation; and conducting, by the one or more processors, claim transferring based on the one or more tasks. In various embodiments, the transferring assets associated with the account of the user to an authenticated transferee may comprise verifying identity information of the transferee as matching with a transferee designated at the account of the user for receiving the assets. In many implementations, such verification may be performed based on identifications such as government issued IDs. In many implementations, a digital version of the identification of the transferee may be verified remotely via an app, a mobile web browser, a web based application, any suitable software, firmware, hardware, or a combination thereof.

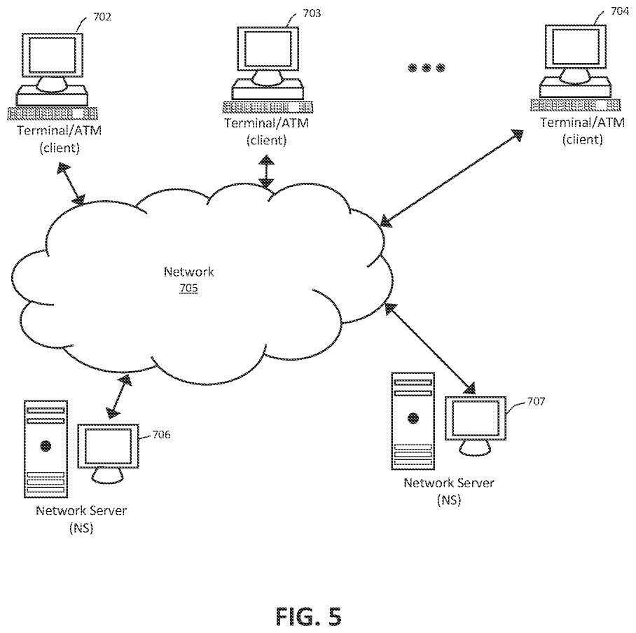

FIG. 5 depicts a block diagram of an exemplary computer-based system/platform in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform may be configured to manage a large number of instances of software applications, users, and/or concurrent transactions, as detailed herein. In some embodiments, the exemplary computer-based system/platform may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 5, members 702-704 (e.g., POS devices or clients) of the exemplary computer-based system/platform may include virtually any computing device capable of receiving and sending a message over a network (e.g., cloud network), such as network 705, to and from another computing device, such as servers 706 and 707, each other, and the like. In some embodiments, the member devices 702-704 may be personal computers, multiprocessor systems, microprocessor-based or programmable consumer electronics, network PCs, and the like. In some embodiments, one or more member devices within member devices 702-704 may include computing devices that typically connect using wireless communications media such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 702-704 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 702-704 may include one or more applications, such as Internet browsers, mobile applications, voice calls, video games, videoconferencing, and email, among others. In some embodiments, one or more member devices within member devices 702-704 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 702-704 may be specifically programmed by either Java, .Net, QT, C, C++ and/or other suitable programming language. In some embodiments, one or more member devices within member devices 702-704 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 705 may provide network access, data transport and/or other services to any computing device coupled to it. In some embodiments, the exemplary network 705 may include and implement at least one specialized network architecture that may be based at least in part on one or more standards set by, for example, without limitation, GlobalSystem for Mobile communication (GSM) Association, the Internet Engineering Task Force (IETF), and the Worldwide Interoperability for Microwave Access (WiMAX) forum. In some embodiments, the exemplary network 705 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 705 may include and implement, as an alternative or in conjunction with one or more of the above, a WiMAX architecture defined by the WiMAX forum. In some embodiments and, optionally, in combination of any embodiment described above or below, the exemplary network 705 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 705 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 705 may also include mass storage, such as network attached storage (NAS), a storage area network (SAN), a content delivery network (CDN) or other forms of computer- or machine-readable media.

In some embodiments, the exemplary server 706 or the exemplary server 707 may be a web server (or a series of servers) running a network operating system, examples of which may include but are not limited to Microsoft Windows Server, Novell NetWare, or Linux. In some embodiments, the exemplary server 706 or the exemplary server 707 may be used for and/or provide cloud and/or network computing. Although not shown in FIG. 5, in some embodiments, the exemplary server 706 or the exemplary server 707 may have connections to external systems like email, SMS messaging, text messaging, ad content providers, etc. Any of the features of the exemplary server 706 may be also implemented in the exemplary server 707 and vice versa.

In some embodiments, one or more of the exemplary servers 706 and 707 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 701-704.

In some embodiments and, optionally, in combination of any embodiment described above or below, for example, one or more exemplary computing member devices 702-704, the exemplary server 706, and/or the exemplary server 707 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

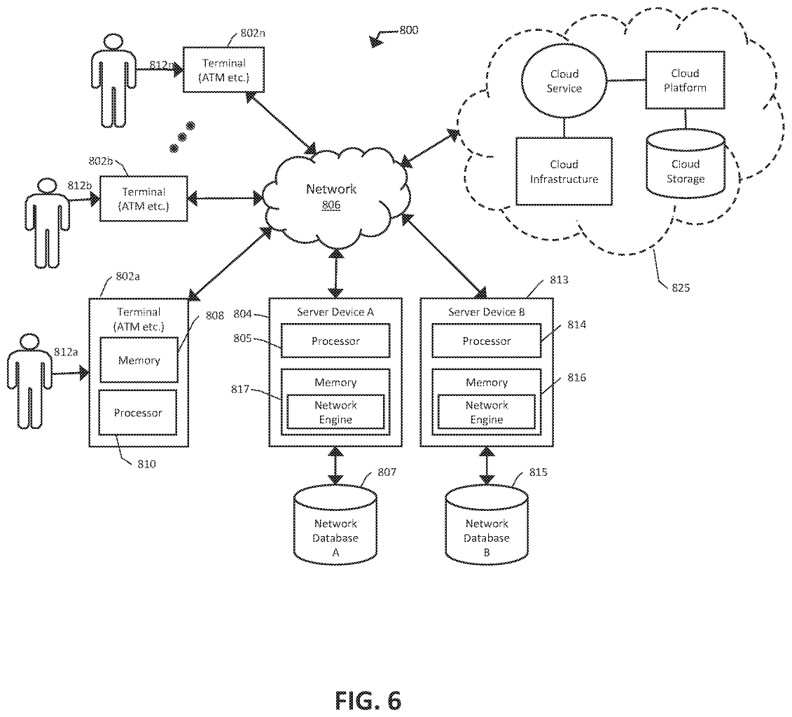

FIG. 6 depicts a block diagram of another exemplary computer-based system/platform 800 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices (e.g., POS devices) 802a, 802b through 802n shown each at least includes computer-readable media, such as a random-access memory (RAM) 808 coupled to a processor 810 and/or memory 808. In some embodiments, the processor 810 may execute computer-executable program instructions stored in memory 808. In some embodiments, the processor 810 may include a microprocessor, an ASIC, and/or a state machine. In some embodiments, the processor 810 may include, or may be in communication with, media, for example computer-readable media, which stores instructions that, when executed by the processor 810, may cause the processor 810 to perform one or more steps described herein. In some embodiments, examples of computer-readable media may include, but are not limited to, an electronic, optical, magnetic, or other storage or transmission device capable of providing a processor, such as the processor 810 of client 802a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other media from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 802a through 802n may also comprise a number of external or internal devices such as a mouse, a CD-ROM, DVD, a physical or virtual keyboard, a display, a speaker, or other input or output devices. In some embodiments, examples of member computing devices 802a through 802n (e.g., clients) may be any type of processor-based platforms that are connected to a network 806 such as, without limitation, personal computers, digital assistants, personal digital assistants, smart phones, pagers, digital tablets, laptop computers, Internet appliances, and other processor-based devices. In some embodiments, member computing devices 802a through 802n may be specifically programmed with one or more application programs in accordance with one or more principles/methodologies detailed herein. In some embodiments, member computing devices 802a through 802n may operate on any operating system capable of supporting a browser or browser-enabled application, such as Microsoft™ Windows™, and/or Linux. In some embodiments, member computing devices 802a through 802n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 802a through 802n, users, 812a through 812n, may communicate over the exemplary network 806 with each other and/or with other systems and/or devices coupled to the network 806.

As shown in FIG. 6, exemplary server devices 804 and 813 may be also coupled to the network 806. In some embodiments, one or more member computing devices 802a through 802n may be mobile clients. In some embodiments, server devices 804 and 813 shown each at least includes respective computer-readable media, such as a random-access memory (RAM) coupled to a respective processor 805, 814 and/or respective memory 817, 816. In some embodiments, the processor 805, 814 may execute computer-executable program instructions stored in memory 817, 816, respectively. In some embodiments, the processor 805, 814 may include a microprocessor, an ASIC, and/or a state machine. In some embodiments, the processor 805, 814 may include, or may be in communication with, media, for example computer-readable media, which stores instructions that, when executed by the processor 805, 814, may cause the processor 805, 814 to perform one or more steps described herein. In some embodiments, examples of computer-readable media may include, but are not limited to, an electronic, optical, magnetic, or other storage or transmission device capable of providing a processor, such as the respective processor 805, 814 of server devices 804 and 813, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other media from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, at least one database of exemplary databases 807 and 815 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

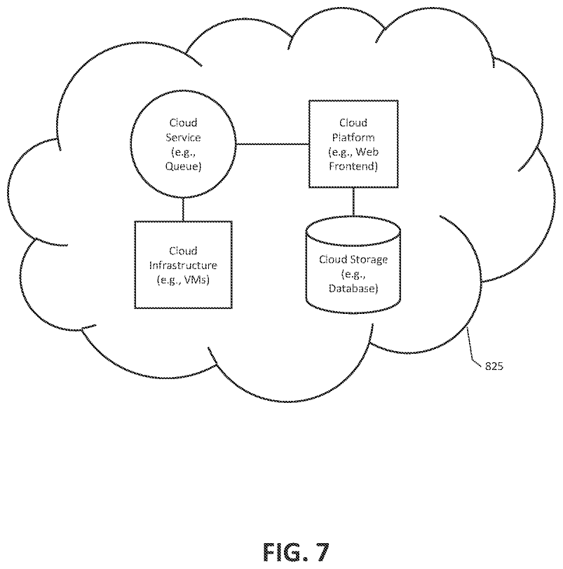

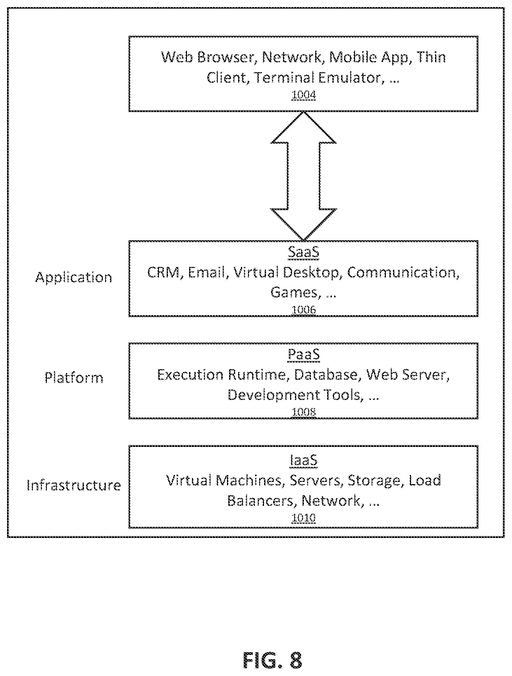

As also shown in FIGS. 7 and 8, some embodiments of the disclosed technology may also include and/or involve one or more cloud components 825, which are shown grouped together in the drawing for sake of illustration, though may be distributed in various ways as known in the art. Cloud components 825 may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.).

According to some embodiments shown by way of one example in FIG. 8, the exemplary inventive computer-based systems/platforms, the exemplary inventive computer-based devices, components and media, and/or the exemplary inventive computer-implemented methods of the present disclosure may be specifically configured to operate in or with cloud computing/architecture such as, but not limiting to: infrastructure a service (IaaS) 1010, platform as a service (PaaS) 1008, and/or software as a service (SaaS) 1006. FIGS. 7 and 8 illustrate schematics of exemplary implementations of the cloud computing/architecture(s) in which the exemplary inventive computer-based systems/platforms, the exemplary inventive computer-implemented methods, and/or the exemplary inventive computer-based devices, components and/or media of the present disclosure may be specifically configured to operate. In some embodiments, such cloud architecture 1006, 1008, 1010 may be utilized in connection with the Web browser and browser extension aspects, shown at 1004, to achieve the innovations herein.

As used in the description and in any claims, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems/platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), Bluetooth™, near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. Various embodiments herein may include interactive posters that involve wireless, e.g., Bluetooth™ and/or NFC, communication aspects, as set forth in more detail further below. In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) are within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components (e.g., FIG. 7-8) and cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a tweet, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) AmigaOS, AmigaOS 4; (2) FreeBSD, NetBSD, OpenBSD; (3) Linux; (4) Microsoft Windows; (5) OpenVMS; (6) OS X (Mac OS); (7) OS/2; (8) Solaris; (9) Tru64 UNIX; (10) VM; (11) Android; (12) Bada; (13) BlackBerry OS; (14) Firefox OS; (15) iOS; (16) Embedded Linux; (17) Palm OS; (18) Symbian; (19) Tizen; (20) WebOS; (21) Windows Mobile; (22) Windows Phone; (23) Adobe AIR; (24) Adobe Flash; (25) Adobe Shockwave; (26) Binary Runtime Environment for Wireless (BREW); (27) Cocoa (API); (28) Cocoa Touch; (29) Java Platforms; (30) JavaFX; (31) JavaFX Mobile; (32) Microsoft XNA; (33) Mono; (34) Mozilla Prism, XUL and XULRunner; (35) .NET Framework; (36) Silverlight; (37) Open Web Platform; (38) Oracle Database; (39) Qt; (40) SAP NetWeaver; (41) Smartface; (42) Vexi; and (43) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, smart watch, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

The aforementioned examples are, of course, illustrative and not restrictive.

As used herein, the term “user” shall have a meaning of at least one user. In some embodiments, the terms “user”, “subscriber”, “consumer”, or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

At least some aspects of the present disclosure will now be described with reference to the following numbered clauses.

Clause 1. A method comprising:
storing, by one or more processors of a platform, a plurality of sets of electronic documents associated with a plurality of users, each set of the plurality of sets of electronic documents corresponding to an account of a user of the plurality of users;
generating, by the one or more processors, a set of metadata items for each electronic document in each set of the plurality of sets of electronic documents, the set of metadata items comprising one or more data fields indicative of states of activities associated with each set of electronic documents;
determining, by the one or more processors, a set of features based on the set of metadata items for each electronic document in each set of the plurality of sets of electronic documents;
transforming, by the one or more processors, the set of features into a set of feature vectors, each feature vector tagged to indicate a correspondence to a particular anomaly or not;
training, by the one or more processors, based at least in part on the set of features vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items;
utilizing, by the one or more processors, the trained data anomaly-detection machine learning model to analyze a particular set of metadata items of at least one particular electronic document associated with an account of a particular user of the plurality of users to detect one or more anomalies in the particular set of metadata items; and
automatically triggering, by the one or more processors and in response to the one or more anomalies, one or more actions associated with the account of the particular user.
   Clause 2. The method of clause 1 or of any clause herein, wherein electronic documents of the plurality sets of documents comprise one or more of: textual data, imagery data, audio data, video data, virtual token data, hologram data, augmented reality data, virtual reality data, and Internet of Things (IoT) data.
   Clause 3. The method of clause 1 or any clause herein, wherein the detecting one or more anomalies in the particular set of metadata items comprises to:
determining, by the one or more processors, whether a risk level associated with the one or more anomalies exceeds a threshold value.
   Clause 4. The method of clause 3 or any clause herein, further comprising determining, by the one or more processors, the threshold value based at least in part on the trained data anomaly-detection machine learning model.
   Clause 5. The method of clause 1 or any clause herein, wherein the utilizing the trained data anomaly-detection machine learning model to analyze the particular set of metadata items of the at least one electronic document associated with the account of the particular user of the plurality of users, further comprises:
scanning, by the one or more processors, the particular set of metadata items of the at least one particular electronic document associated with the account of the particular user of the plurality of users to detect one or more changes in the particular set of metadata items.
   Clause 6. The method of clause 5 or any clause herein, wherein the detecting one or more anomalies in the particular set of metadata items further comprises:
determining, by the one or more processors, the one or more anomalies in the account of the user based on the one or more changes in the particular set of metadata items.
   Clause 7. The method of clause 1 or any clause herein, wherein the feature vectors are associated with a set of metadata items of historical electronic documents.
   Clause 8. The method of clause 1 or any clause herein, wherein the automatically triggering, by the one or more processors and in response to the one or more anomalies, one or more actions associated with the account of the user comprises:
generating a security token, by the one or more processors, in response to the one or more anomalies; and
initiating, by the one or more processors, the automatically triggering of the one or more actions associated with the account of the user based on the security token.
   Clause 9. The method of clause 1 or any clause herein, wherein the automatically triggering, by the one or more processors and in response to the one or more anomalies, one or more actions associated with the account of the user comprises transferring of electronic documents of the set of electronic documents of the user.
   Clause 10. The method of clause 1 or any clause herein, wherein the data anomaly-detection machine learning model comprises one or more cascade-based models, a cascade-model of the one or more cascade-models comprising a plurality of stages including a first stage associated with a first model and a first detection threshold, and a second stage associated with a second model and a second detection threshold, wherein the cascade-model progresses into the second stage to apply the second model to a second subset of the metadata only when an anomaly is detected in the first stage by applying the first model to a first subset of the metadata.
   Clause 11. The method of clause 1 or any clause herein, wherein the activities comprise: credit reporting events, merchant events, financial account events, legal events, municipal regulation events, motor vehicle regulation events, household usage and maintenance events, and healthcare events.
   Clause 12. The method of clause 11 or any clause herein, wherein the financial account events comprises one or more new account events and one or existing account events, the one or more new account events comprising a new credit card event, a new personal loan event, a new loan application event, a new car purchase event, a new car loan event, a new mortgage event, a new insurance policy event, a new mobile phone account event, a new utility account event, a new co-signor on a loan event, and a new reverse mortgage event; and the one or more existing account event comprising: a credit card event, a payment event, a purchase event, an identity event, an authentication event, a balance event, and a ownership event.
   Clause 13. The method of clause 1 or any clause herein, wherein the one more actions associated with the account of the user comprise: modifying an access permission to the account associated with the user, delegating another entity to monitor the account of the user, and transferring assets associated with the account of the user to an authenticated transferee.
   Clause 14. The method of clause 13 or any clause herein, wherein the automatically triggering, by the one or more processors and in response to the one or more anomalies, one or more actions associated with the account of the user, comprises:
generating, by the one or more processors, one or more tasks in response to one or more anomalies;
notifying, by the one or more processors, one or more of: the user, the another entity, and the authenticated transferee;
transmitting, by the one or more processors and in response to a confirmation the one or more of the user, the another entity and the authenticated transferee, the one or more tasks to the one or more of the user, the another entity and the authenticated transferee who sends the confirmation; and
conducting, by the one or more processors, claim transferring based on the one or more tasks. Clause 15. The method of clause 13 or any clause herein, wherein the transferring assets associated with the account of the user to an authenticated transferee comprises verifying identify information of the transferee as matching with a transferee designated at the account of the user for receiving the assets.
   Clause 16. A system comprising:
one or more processors; and
a memory in communication with the one or more processors and storing instructions that,
when executed by the one or more processors, cause the one or more processors to:
   store a plurality of sets of electronic documents associated with a plurality of users, each set of the plurality of sets of electronic documents corresponding to an account of each user of the plurality of users;
   generate a set of metadata items for each document in each set of the plurality of sets of electronic documents, the set of metadata items comprising one or more data fields indicative of states of activities associated with each set of electronic documents;
   determine a set of features based on the set of metadata items for each electronic document in each set of the plurality of sets of electronic documents;
   transform the set of features into a set of feature vectors, each feature vector tagged to indicate a correspondence to a particular anomaly or not;
   train, based at least in part on the set of features_vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items;
   utilize the trained data anomaly-detection machine learning model to analyze a particular set of metadata items of at least one particular electronic document associated with an account of a particular user of the plurality of users to detect one or more anomalies in the particular set of metadata items; and
   automatically trigger, by the one or more processors and in response to the one or more anomalies, one or more actions associated with the account of the particular user.
      Clause 17. The method of clause 16 of any clause herein, wherein electronic documents of the plurality sets of documents comprise one or more of: textual data, imagery data, audio data, video data, virtual token data, hologram data, augmented reality data, virtual reality data, and Internet of Things (IoT) data.
      Clause 18. The method of clause 16 of any clause herein, wherein the utilizing the trained data anomaly-detection machine learning model to analyze the particular set of metadata items of the at least one electronic document associated with the account of the particular user of the plurality of users, further comprises:
scanning, by the one or more processors, the particular set of metadata items of the at least one particular electronic document associated with the account of the particular user of the plurality of users to detect one or more changes in the particular set of metadata items.
   Clause 19. The method of clause 18 of any clause herein, wherein the detecting one or more anomalies in the particular set of metadata items further comprises:
determining, by the one or more processors, the one or more anomalies in the account of the user based on the one or more changes in the particular set of metadata items.
   Clause 20. A non-transitory computer readable storage medium for tangibly storing computer program instructions capable of being executed by a computer processor, the computer program instructions defining the steps of:
storing, by one or more processors of a platform, a plurality of sets of electronic documents associated with a plurality of users, each set of the plurality of sets of electronic documents corresponding to an account of a user of the plurality of users;
generating, by the one or more processors, a set of metadata items for each electronic document in each set of the plurality of sets of electronic documents, the set of metadata items comprising one or more data fields indicative of states of activities associated with each set of electronic documents;
determining, by the one or more processors, a set of features based on the set of metadata items for each electronic document in each set of the plurality of sets of electronic documents;
transforming, by the one or more processors, the set of features into a set of feature vectors, each feature vector tagged to indicate a correspondence to a particular anomaly or not;
training, by the one or more processors, based at least in part on the set of features vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items;
utilizing, by the one or more processors, the trained data anomaly-detection machine learning model to analyze a particular set of metadata items of at least one particular electronic document associated with an account of a particular user of the plurality of users to detect one or more anomalies in the particular set of metadata items; and
automatically triggering, by the one or more processors and in response to the one or more anomalies, one or more actions associated with the account of the user.

1. A method comprising:
storing, by one or more processors of a platform, a plurality of sets of electronic documents associated with a plurality of users, each set of the plurality of sets of electronic documents corresponding to an account of each user of the plurality of users;
generating, by the one or more processors, a set of metadata items for each electronic document in each set of the plurality of sets of electronic documents, the set of metadata items comprising one or more data fields indicative of states of activities associated with each set of electronic documents;
determining, by the one or more processors, a set of features based on the set of metadata items for each electronic document in each set of the plurality of sets of electronic documents;
transforming, by the one or more processors, the set of features into a set of feature vectors, each feature vector tagged to indicate a correspondence to a particular anomaly or not;
training, by the one or more processors, based at least in part on the set of features vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items;
utilizing, by the one or more processors, the trained data anomaly-detection machine learning model to analyze a particular set of metadata items of at least one particular electronic document associated with an account of a particular user of the plurality of users to detect one or more anomalies in the particular set of metadata items; and
automatically triggering, by the one or more processors and in response to the one or more anomalies, one or more actions associated with the account of the particular user.

2. The method of claim 1, wherein electronic documents of the plurality sets of electronic documents comprise one or more of: textual data, imagery data, audio data, video data, virtual token data, hologram data, augmented reality data, virtual reality data, and Internet of Things (IoT) data.

3. The method of claim 1, wherein the detecting one or more anomalies in the particular set of metadata items comprises:
determining, by the one or more processors, whether a risk level associated with the one or more anomalies exceeds a threshold value.

4. The method of claim 3, further comprising:
determining, by the one or more processors, the threshold value based at least in part on the trained data anomaly-detection machine learning model.

5. The method of claim 1, wherein the utilizing the trained data anomaly-detection machine learning model to analyze the particular set of metadata items of the at least one electronic document associated with the account of the particular user of the plurality of users, further comprises:
scanning, by the one or more processors, the particular set of metadata items of the at least one particular electronic document associated with the account of the particular user of the plurality of users to detect one or more changes in the particular set of metadata items.

6. The method of claim 5, wherein the detecting one or more anomalies in the particular set of metadata items further comprises:
determining, by the one or more processors, the one or more anomalies in the account of the user based on the one or more changes in the particular set of metadata items.

7. The method of claim 1, further comprising:
associating, by the one or more processors, the feature vectors with a set of metadata items of historical electronic documents.

8. The method of claim 1, wherein the automatically triggering, by the one or more processors and in response to the one or more anomalies, one or more actions associated with the account of the user comprises:
generating a security token, by the one or more processors, in response to the one or more anomalies; and
initiating, by the one or more processors, the automatic triggering of the one or more actions associated with the account of the user based on the security token.

9. The method of claim 1, wherein the automatically triggering, by the one or more processors and in response to the one or more anomalies, one or more actions associated with the account of the user comprises transferring of electronic documents of the set of electronic documents of the user.

10. The method of claim 1, wherein the data anomaly-detection machine learning model comprises one or more cascade-based models, a cascade-model of the one or more cascade-models comprising a plurality of stages including a first stage associated with a first model and a first detection threshold, and a second stage associated with a second model and a second detection threshold, wherein the cascade-model progresses into the second stage to apply the second model to a second subset of the metadata only when an anomaly is detected in the first stage by applying the first model to a first subset of the metadata.

11. The method of claim 1, wherein the activities comprise: credit reporting events, merchant events, financial account events, legal events, municipal regulation events, motor vehicle regulation events, household usage and maintenance events, and healthcare events.

12. The method of claim 11, wherein the financial account events comprises one or more new account events and one or existing account events, the one or more new account events comprising a new credit card event, a new personal loan event, a new loan application event, a new car purchase event, a new car loan event, a new mortgage event, a new insurance policy event, a new mobile phone account event, a new utility account event, a new co-signer on a loan event, and a new reverse mortgage event; and the one or more existing account event comprising: a credit card event, a payment event, a purchase event, an identity event, an authentication event, a balance event, and a ownership event.

13. The method of claim 1, wherein the one more actions associated with the account of the user comprise: modifying an access permission to the account associated with the user, delegating another entity to monitor the account of the user, and transferring assets associated with the account of the user to an authenticated transferee.

14. The method of claim 13, wherein the automatically triggering, by the one or more processors and in response to the one or more anomalies, one or more actions associated with the account of the user, comprises:
generating, by the one or more processors, one or more tasks in response to one or more anomalies;
notifying, by the one or more processors, one or more of: the user, the another entity, and the authenticated transferee;
transmitting, by the one or more processors and in response to a confirmation the one or more of the user, the another entity and the authenticated transferee, the one or more tasks to the one or more of the user, the another entity and the authenticated transferee who sends the confirmation; and
conducting, by the one or more processors, claim transferring based on the one or more tasks.

15. The method of claim 13, wherein the transferring assets associated with the account of the user to an authenticated transferee comprises verifying identity information of the transferee as matching with a transferee designated at the account of the user for receiving the assets.

16. A system comprising:
one or more processors; and
a memory in communication with the one or more processors and storing instructions that,
when executed by the one or more processors, cause the one or more processors to:
store a plurality of sets of electronic documents associated with a plurality of users, each set of the plurality of sets of electronic documents corresponding to an account of each user of the plurality of users;
generate a set of metadata items for each document in each set of the plurality of sets of electronic documents, the set of metadata items comprising one or more data fields indicative of states of activities associated with each set of electronic documents;
determine a set of features based on the set of metadata items for each electronic document in each set of the plurality of sets of electronic documents;
transform the set of features into a set of feature vectors, each feature vector tagged to indicate a correspondence to a particular anomaly or not;
train, based at least in part on the set of features_vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items;
utilize the trained data anomaly-detection machine learning model to analyze a particular set of metadata items of at least one particular electronic document associated with an account of a particular user of the plurality of users to detect one or more anomalies in the particular set of metadata items; and
automatically trigger, in response to the one or more anomalies, one or more actions associated with the account of the particular user.

17. The system of claim 16, wherein electronic documents of the plurality sets of electronic documents comprise one or more of: textual data, imagery data, audio data, video data, virtual token data, hologram data, augmented reality data, virtual reality data, and Internet of Things (IoT) data.

18. The system of claim 16, wherein to utilize the trained data anomaly-detection machine learning model to analyze the particular set of metadata items of the at least one electronic document associated with the account of the particular user of the plurality of users further comprises to:
scan the particular set of metadata items of the at least one particular electronic document associated with the account of the particular user of the plurality of users to detect one or more changes in the particular set of metadata items.

19. The system of claim 18, to detect one or more anomalies in the particular set of metadata items further comprises to:
determine the one or more anomalies in the account of the user based on the one or more changes in the particular set of metadata items.

20. A non-transitory computer readable storage medium for tangibly storing computer program instructions capable of being executed by a computer processor, the computer program instructions defining the steps of:
storing a plurality of sets of electronic documents associated with a plurality of users, each set of the plurality of sets of electronic documents corresponding to an account of a user of the plurality of users;
generating a set of metadata items for each electronic document in each set of the plurality of sets of electronic documents, the set of metadata items comprising one or more data fields indicative of states of activities associated with each set of electronic documents;
determining a set of features based on the set of metadata items for each electronic document in each set of the plurality of sets of electronic documents;
transforming the set of features into a set of feature vectors, each feature vector tagged to indicate a correspondence to a particular anomaly or not;
training based at least in part on the set of features vectors, a data anomaly-detection machine learning model to obtain a trained data anomaly-detection machine learning model, the data anomaly-detection machine learning model comprising a set of triggering rules that are configured to determine a plurality of anomalies within a particular set of metadata items;
utilizing the trained data anomaly-detection machine learning model to analyze a particular set of metadata items of at least one particular electronic document associated with an account of a particular user of the plurality of users to detect one or more anomalies in the particular set of metadata items; and
automatically triggering, in response to the one or more anomalies, one or more actions associated with the account of the user.
